(19) United States
(12) Patent Application Publication
(10) Pub. No.: US 2015/0238377 A1
(43) Pub. Date: Aug. 27, 2015

(54) Patient Bedside System Support Device

(71) Applicant: Wali Muhammad, Riverside, CA (US)

(72) Inventor: Wali Muhammad, Riverside, CA (US)

(21) Appl. No.: 14/628,132

(22) Filed: Feb. 20, 2015

Related U.S. Application Data
(60) Provisional application No. 61/942,741, filed on Feb. 21, 2014.

(51) Int. Cl. A61G 7/05; F16L 3/13; F16B 2/10; F16M 13/02; F16B 2/06

(52) U.S. Cl. CPC A61G 7/05; F16M 13/022; F16B 2/065; F16B 2/10; F16L 3/13

(57) ABSTRACT

Provided is a bedside support for a patient bed that is configured to support various systems extending across the threshold of the patient bed. The device comprises a lower portion having a bed rail clamp assembly that secures the device in an upright condition from a patient bed rail adjacent to the patient. Extending above the lower portion is an upper portion that includes at least one system clip, whereby the system clips are configured to support lines, wires, and tubes extending from various bedside systems and to the patient. The upper portion may be pivotable relative to the lower portion, and along the backside surface of the lower portion is at least one clip for supporting a suction yankauer therefrom. The assembly organizes various systems extending over the threshold of a patient bed in a hospital or similar treatment environment.

### CROSS REFERENCE TO RELATED APPLICATION

This application claims the benefit of U.S. Provisional Application No. 61/942,741 filed on Feb. 21, 2014, entitled “Universal Tube and Suction Holder.” The above identified patent application is herein incorporated by reference in its entirety to provide continuity of disclosure.

### BACKGROUND OF THE INVENTION

### Field of the Invention

The present invention relates to a hospital bedside support for tubes, hoses, and other lines extending across the threshold of the bed for patient use. More specifically, the present invention relates to a hospital equipment support that is affixable to the rails of a hospital bed to prevent entanglements with necessary tubes, hoses, and lines being supplied to the patient.

Patients in hospitals are often connected to a variety of medical devices for ongoing treatment or life support. This is particularly true for patient in an intensive care unit being treated for extensive medical issues. Common appliances include breathing tubes, various catheter lines for introduce medication and pain therapies, electrodes and monitoring devices, as well as various pumps and hoses. Generally a patient is connected to these several treatment devices by way of various tubes, wires, and lines that extend from the patient and to equipment controlling or otherwise operating in conjunction therewith.

Generally these lines are placed over and around a patient and extend across the bedside threshold. This can be uncomfortable for a still-ambulatory patient and creates a risk of entanglement or traction on the various lines. As a result, organization of these systems and their placement on the bed must be tended to and accounted for while treating the patient or when the patient needs to move.

The placement of the tubes may inhibit the movement of the patient during various activities, including cleaning activities and shifting the patient within the bed for various procedures. The present invention provides a bedside support that is configured to support tubes, wires, and other systems from the threshold of the bed, thereby organizing the various lines connected to the patient. Specifically, the assembly is configured to secure to the bed rail of a patient bed and provide support members for enlarged breathing tubes, for lines, and for probes that extend over the bed and to the patient. The device moreover supports a suction yankauer therefrom.

### SUMMARY OF THE INVENTION

The following summary is intended solely for the benefit of the reader and is not intended to be limiting in any way. The present invention provides a new bedside system support device for a patient bed, wherein the same can be utilized for providing convenience for patients and healthcare providers when organizing various systems extending across the threshold of a patient bed.

It is therefore an object of the present invention to provide a new and improved bedside support device that has all of the advantages of the prior art and none of the disadvantages.

It is another object of the present invention to provide a bedside support device that is configured to secure to a substantially horizontal side rails of a patient bed in a hospital or care facility, whereby the device supports various systems cross the threshold of the bed to the patient.

Another object of the present invention is to provide a bedside support device that supports various lines, wires, and tubes along the side or end of a patient bed.

Yet another object of the present invention is to provide a bedside support device that organizes and arranges medical systems that extend across the threshold of a patient.

Another object of the present invention is to provide a bedside support device that includes a generic bed rail clamp assembly that can affix to most any patient bed without modification.

Another object of the present invention is to provide a bedside support device that supports a suction yankauer along a side of the device and provides a cover thereover when the yankauer is not in use.

Another object of the present invention is to provide a bedside support device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a frontal perceptive view of the bedside support device of the present invention.

FIG. 2 shows a rear perceptive view of the bedside support device of the present invention.

FIG. 3 shows an end view of the bed rail clamp assembly along the lower portion of the device.

FIG. 4 shows a rear view of the bedside support device and the suction yankauer support therealong.

FIG. 5 shows an overhead perspective view of the bedside support device of the present invention in a working state, supporting breathing tubes extending across the threshold of the patient bed.

### DETAILED DESCRIPTION OF THE INVENTION

Reference is made herein to the attached drawings. Like reference numerals are used throughout the drawings to depict like or similar elements of the bedside support device of the present invention. For the purposes of presenting a brief and clear description of the present invention, the preferred embodiment will be discussed as used for supporting tubes, lines, and other equipment along a rail of a patient bed, whereby the systems are organized and supported in a static configuration from the device. The figures are intended for representative purposes only and should not be considered to be limiting in any respect.

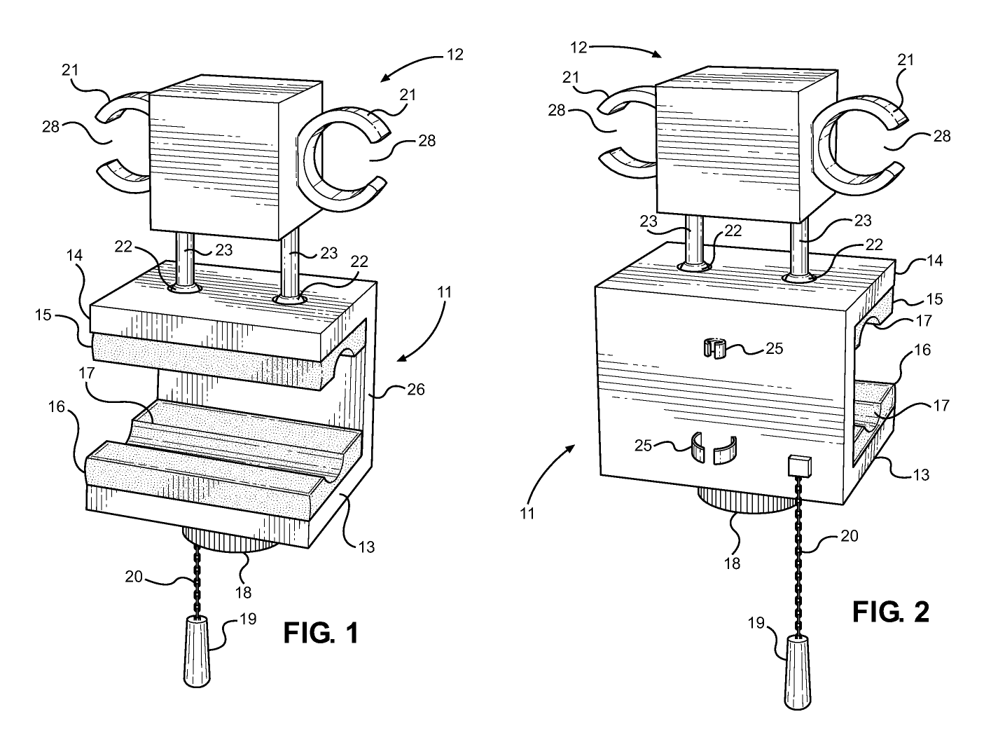

Referring now to FIGS. 1 and 2, there are shown views of the bedside system support device of the present invention from the front and from the rear perspective. The bedside system support device is one that is configured to secure to an exposed structure adjacent to a patient bed, such as a bed rail or an adjacent table, and support one or more system lines between the user in the bed and the system apparatus situated adjacent to the bed. The system lines may include tubes, wires, catheter lines, or other system lines that extend from an article of equipment and to a user on the bed. The bedside system support device supports the lines along their length and organizes them as they cross the threshold of the bed and connect to the patient.

The bedside system support device comprises a lower portion 11 and an upper portion 12, whereby the lower portion 11 is configured to be affixed to the exposed structure on or near the bed and the upper portion 12 supports the system lines being tended to. The upper portion 12 is connected to the lower portion 11 such that the upper portion 12 is preferably disposed above the lower portion 11. In one embodiment and as depicted in the drawing views, the upper portion 12 is connected to the lower portion 11 via elongated members 23 that extend therebetween. The members 23 may statically join the two portions, or alternatively the members 23 may be pivotably connected 22 between the portions such that the upper portion 12 can pivot relative to the lower portion 11 when the lower portion 11 is affixed to a support and the upper portion 12 is supported system lines. A pivot joint along the members 23 allow the upper portion 12 to move relative to the lower portion 11. In a preferred configuration, the pivot joint 22 is disposed along the lowermost extent of each elongated member 23 and allows the elongated members to move relative to the lower portion 11. The pivot joint 22 may be one of a revolute joint, ball joint, or similar joint that allows the upper portion 12 to move relative to the lower portion 11 when the lower portion 11 is statically supported.

The upper portion 12 is adapted to support the system lines and therefore support the weight thereof at the point of intersection between the lines and the upper portion 12. At least one equipment clip 21 is used to support the system lines along the upper portion. The equipment clip 21 may comprises a static support member or one that is movable, whereby the clip can enclose a line against the upper portion 12. In a non-limiting, preferred configuration of the equipment clips 21, each comprises a substantial C-shaped member with a pair of clip arms extending from a side of the upper portion 12. The pair of clip arms extends outward and forms a partially enclosed and open interior volume. Access into the open interior volume is achieved via a separation between the clip arms that forms an open section 28 in the equipment clip 21. This allows lines to be inserted through the open section 28 and into the open interior thereof for support by the lower clip arm. Alternatively configurations of the equipment clips are contemplated, falling within the scope of supporting a system line along its length at a point along the upper portion.

The lower portion 11 is one that is configured to be mounted to a support structure on the patient bed or on a structure adjacent thereto. The patient bed is a bed structure that may be one of a bed used in a medical environment or one that is used suitable for use in the home. It is not desired to limit the present invention to a particular type of bed, such as a hospital bed with specific features. It is contemplated that the present invention can function in coordination with any bed or cot device, and in any suitable environment in which system lines are extending across the bed from an adjacent therapy apparatus and to a user on the bed surface. Similarly, the therapy apparatus may be one of several machines or devices used to treat or monitor the user on the bed. These include various medical equipment devices and other therapeutic machines. Non-limiting examples include ventilation therapy devices, intravenous and catheter medical devices, patient monitors, and the like. The system lines include any elongated wire, line, tube, or lead that extends between a therapy apparatus and the patient, whereby the system line has an elongated length. The elongated length is supported at a point therealong by the equipment clip of the present invention.

The lower portion affixes to an exposed structure, whereby the exposed structure is one that allows a movable clamp to secure against a pair of opposing sides thereof and bear thereagainst to frictionally support the lower portion therealong. The preferred mounting location of the lower portion 11 is that of a patient bed rail. However, other non-limiting examples include ledges of adjacent furniture, the side of the bed itself or the mattress, or any other exposed structure suitable for the clamping attachment described above. In a preferred embodiment, the lower portion supports a movable clamp member 16 that is configured to clamp against an exposed structure and secure the lower portion 11 thereto. The movable clamp member 16 moves with a C-shaped lower portion 11 that is comprised of an upper surface 14, a lower surface 14, and an intermediate connecting surface 26. The movable clamp member 16 is movable between the lower surface 13 and the upper surface 14, whereby the structure is clamped between the movable member 16 and the upper surface 14.

In yet another preferred configuration of the lower portion 11, the movable clamp member 16 and the lower portion of the upper surface 14 include a pair of complimentary channels 17 that form an enclosed cross section area when the movable member 16 is fully extended against the upper surface 14. The upper surface 14 directly support the upper channel, or alternatively an intermediate surface 15 below the upper surface 14 may include the channel through its cross section. The channels 17 are configured to facilitate attachment to a rounded patient bed rail, which is one structure contemplated to be utilized as support for the lower portion 11. The movable clamp member 16 and the intermediate surface 15 may include elastomeric or compressible material such as rubber or the like, which facilitates clamping without causing damage to the bedrail, while also inhibiting sliding of the device once clamped.

Referring specifically to FIG. 2, there is shown a rear view of the bedside system support device of the present invention. The lower portion 11 further comprises one or more suction yankauer clips 25 thereon that are adapted to support a suction yankauer from the lower portion 11. A suction yankauer is a suction tool common in many medical procedures. The clips 25 are configured to support the suction yankauer along the lower portion 11, while a yankauer tip cover 19 is tethered to the lower portion 11 via an elongated tether 20. The cover 19 is one that includes an elongated, cylindrical body having an open interior, an open end, and a closed end secured to the tether 20. The tip of the suction yankauer is inserted into the open end of the cover 19 and the cover secures the working end of the suction yankauer when stowed against the lower portion 11.

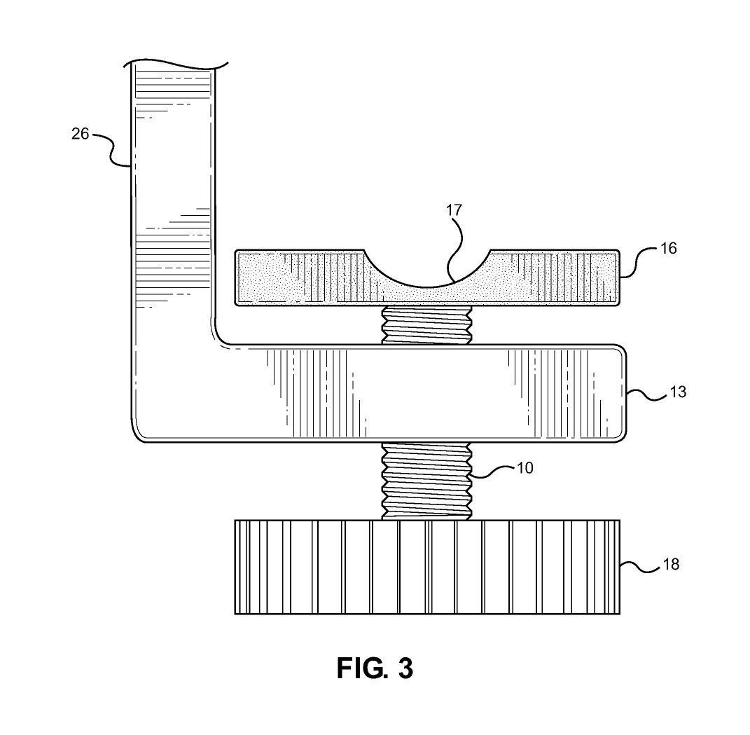

Referring now to FIG. 3, there is shown a close-up view of the lower surface 13 of the lower portion, whereby the movable member 16 is presented. The movable member 16 moves linearly between the lower surface 13 and the upper surface of the lower portion, and in a direction parallel to the height of the connecting middle portion 26 (i.e. vertically in FIG. 3). The movable member 16 is a substantially rectangular member that may have a bed rail channel 17 through its cross section. Driving the movable member 16 is preferably a threaded member 10 that connects to the movable member 16 and is positioned through a threaded aperture in the lower surface 13. The upper end of the threaded member 16 is freely rotating within its connection with the movable member 16, whereby rotation of the threaded member 16 does not impart rotation on the movable member 16. The user controls the position and thus the force on the clamped exposed structure using the threaded member 10, which controls the position of the movable member relative to the lower surface 13. A lowermost grip 18 is used to advance or retract the threaded member 10, and therefore raise or lower the movable member within the interior of the lower portion 11. Alternate configurations of the movable member are contemplated, falling within the scope of providing a movable member within the lower portion that can operably clamp an exposed structure between the lower portion and the movable member.

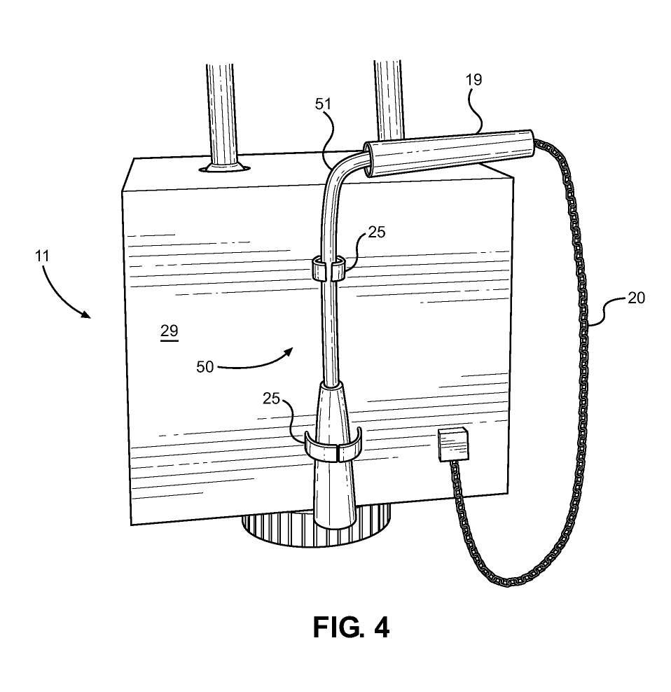

Referring now to FIG. 4, there is shown another rear view of the lower portion 11. This view shows a typical suction yankauer 50 supported by the suction yankauer clips 25 of the lower portion. In a preferred location, the suction yankauer clips 25 are disposed along a rear surface 29 of the lower portion 11, and are vertically aligned to support the body of the suction yankauer 50 in an upright condition. Since the suction yankauer 50 is generally used as an oral appliance, the working end of the suction yankauer 50 can be covered to maintain sanitary conditions thereof between uses. The yankauer tip cover 19 is therefore designed to shroud the working end thereof. The yankauer tip cover 19 extends along the body of the suction yankauer 50 to the bend 51 therealong. If a linear suction yankauer 50 is used, the cover 19 shrouds an elongated portion of its working end. When not in use, the cover 19 is supported by a tether 20 connected to the lower portion 11.

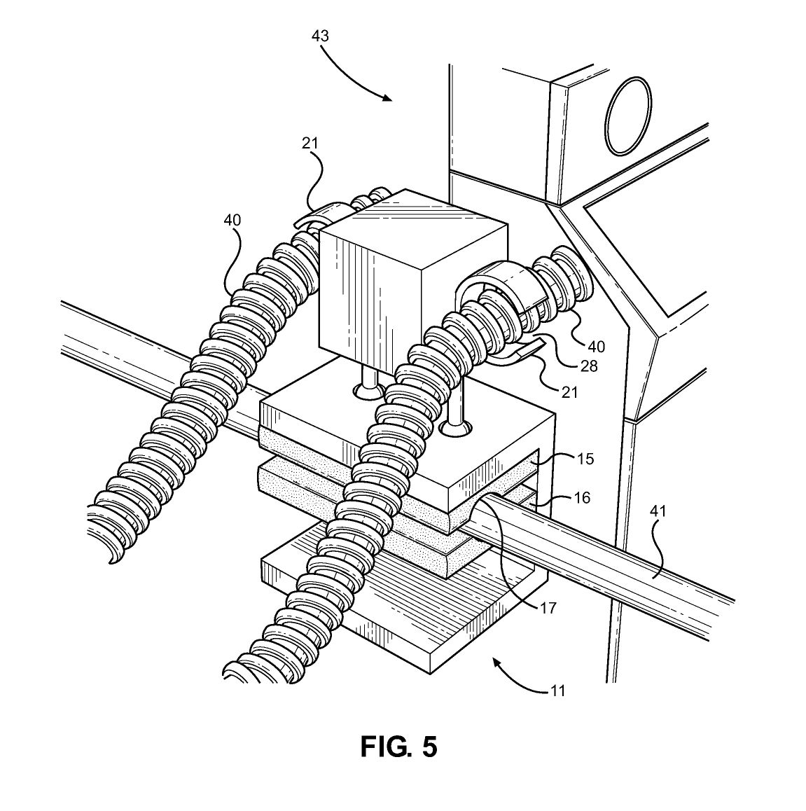

Referring finally to FIG. 5, there is shown a view of the bedside system support device of the present invention in a working state. In this view, the movable member 16 of the lower portion 11 is clamped to a bed rail 41 of a patient bed. The outer surface profile of the bed rail 41 is supported within the channels 17 of the movable member and the intermediate surface 15 within the lower portion. Each of the channels 17 form a portion of a rounded channel that are each adapted to support a portion of the outer profile of the bed rail 41. The movable clamp member 16 comprises a first channel therealong suitable for supporting a portion of the outer profile of a bed rail 41 therein, while the upper surface or the intermediate surface 15 comprises a complimentary second channel that is suitable for supporting an opposite portion of the outer profile of a bed rail 41 relative to the first channel. The movable member 16 is tightened against the bed rail 41 such that the bed rail 41 is sandwiched within the lower portion 11, statically supporting the lower portion 11 therefrom.

The lower portion 11 remains statically affixed to the bed structure while the upper portion supports a pair of ventilator tubes 40 across the threshold of the bed. The tubes 40 are one form of system line that extend from a therapy apparatus 43 adjacent to the bed and extend over the threshold of the bed to the user thereon. The system line support clips 21 support the ventilator tubes 40 within their open interiors after being inserted through the open section 28 in their cross section. Once therein, the upper portion maintains the general position of the tubes 40 while the tubes are in use, thereby organizing the patient area and preventing tension on the apparatus 43 if the tubes are pulled by the patient. The upper portion supports the tubes 40 at a point along their length and maintains their general position, whereby incremental movement may be accommodated if the upper portion is pivotably connected to the lower portion.

Patients receiving therapeutic treatments are often connected to a variety of medical systems lines, such as breathing tubes, lines, and wires. These system lines are often draped across the user's body and the patient area on the bed, which may be uncomfortable for the patient. Further, the placement of the tubes may inhibit the movement of the patient in the bed. The system lines may drag along the ground between the patient's bed and the device to which the tubing is connected, which can result in contamination of the tube due to the exposure of the tubing to unsanitary surfaces. Additional medical issues may arise as result of pulled lines, improper connections, or contaminations resulting from the lines not properly tended to between the patient and the adjacent medical apparatus. Therefore, the present invention provides a device that can support system lines and organize the patient area, whereby the lines are supported at a point along their length as they cross the threshold into the patient bed area.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the claimed invention.

I claim:

1) A bedside system support device for supporting equipment along the threshold of a patient bed, comprising:
an upper portion and a lower portion;
the lower portion comprising a clamp assembly;
the clamp assembly having at least one movable clamp member that is configured to clamp against an exposed structure and secure the lower portion thereto;
the upper portion comprising a least one equipment clip therealong;
each of the equipment clips being adapted to support an elongated system line at a point along the system line and support the point along the upper portion.

2) The bedside system support device of claim 1, wherein:
the lower portion comprises a substantial U-shape with an upper surface, a lower surface, and a connecting middle portion;
the movable clamp member is movable between the lower surface and the upper surface of the lower portion, whereby the movable clamp member is configured to clamp an exposed structure between the movable member and the upper surface of the lower portion.

3) The bedside system support device of claim 2, wherein:
the movable clamp member is movably controlled by a threaded member extending through a threaded aperture in the lower surface of the lower portion.

4) The bedside system support device of claim 1, wherein:
the lower portion comprises a substantial U-shape with an upper surface, a lower surface, and a connecting middle portion;
the movable clamp member is movable between the lower surface and the upper surface of the lower portion, whereby the movable clamp member is configured to clamp a bed rail structure between the movable member and the upper surface of the lower portion.

5) The bedside system support device of claim 1, wherein:
the lower portion further comprises one or more suction yankauer clips thereon that are adapted to support a suction yankauer from the lower portion.

6) The bedside system support device of claim 1, wherein:
the lower portion further comprises one or more suction yankauer clips thereon that are adapted to support a suction yankauer from the lower portion;
the lower portion further comprises a suction yankauer cover tethered to the lower portion, whereby the suction yankauer cover is configured to cover the working end of a suction yankauer when the suction yankauer is affixed by the one or more suction yankauer clips.

7) The bedside system support device of claim 1, wherein:
the lower portion and upper portion are affixed to one another via pivotable members, whereby the upper portion can pivot relative to the lower portion.

8) The bedside system support device of claim 1, wherein:
the lower portion comprising a substantially U-shape with an upper surface, a lower surface, and a connecting middle portion;
the movable clamp member is movable between the lower surface and the upper surface of the lower portion, whereby the movable clamp member is configured to clamp an exposed structure between the movable member and the upper surface of the lower portion;
the movable clamp member comprises a first channel therealong suitable for supporting a portion of the outer profile of a bed rail therein; and
the upper surface comprises a complimentary second channel that is suitable for supporting an opposite portion of the outer profile of a bed rail relative to the first channel therein.

9) The bedside system support device of claim 1, wherein:
each of the equipment clips comprise substantial C-shapes with a pair of clip arms, an open interior, and an open section between the clip arms that permits placement of tubes, wires, and lines into the open interior through the open section.

10) A bedside system support device for supporting equipment along the threshold of a patient bed, comprising:
an upper portion and a lower portion;
the lower portion comprising a substantially U-shape with an upper surface, a lower surface, and a connecting middle portion;
the lower portion further comprising a clamp assembly;
the clamp assembly having at least one movable clamp member movable between the lower surface and the upper surface of the lower portion, whereby the movable clamp member is configured to clamp an exposed structure between the movable member and the upper surface of the lower portion;
the movable clamp member being controlled by a threaded member extending through a threaded aperture in the lower surface of the lower portion;
the upper portion comprising a least one equipment clip therealong;
each of the equipment clips being adapted to support an elongated system line at a point along the system line and support the point along the upper portion.

11) The bedside system support device of claim 10, wherein:
the exposed structure further comprises a bed rail structure.

12) The bedside system support device of claim 10, wherein:
the lower portion further comprises one or more suction yankauer clips thereon that are adapted to support a suction yankauer from the lower portion.

13) The bedside system support device of claim 10, wherein:
the lower portion further comprises one or more suction yankauer clips thereon that are adapted to support a suction yankauer from the lower portion;
the lower portion further comprises a suction yankauer cover tethered to the lower portion, whereby the suction yankauer cover is configured to cover the working end of a suction yankauer when the suction yankauer is affixed by the one or more suction yankauer clips.

14) The bedside system support device of claim 10, wherein:
the lower portion and upper portion are affixed to one another via pivotable members, whereby the upper portion can pivot relative to the lower portion.

15) The bedside system support device of claim 10, wherein:
the movable clamp member comprises a first channel therealong suitable for supporting a portion of the outer profile of a bed rail therein; and
the upper surface comprises a complimentary second channel that is suitable for supporting an opposite portion of the outer profile of a bed rail relative to the first channel therein.

16) The bedside system support device of claim 10, wherein:
each of the equipment clips comprise substantial C-shapes with a pair of clip arms, an open interior, and an open section between the clip arms that permits placement of tubes, wires, and lines into the open interior through the open section.
